(19) United States
(12) Patent Application Publication
(10) Pub. No.: US 2023/0144021 A1
(43) Pub. Date: May 11, 2023

(54) THERMAL PROTECTION PLUG

(71) Applicant: INGENIO TECHNOLOGY CO., LIMITED, Chai Wan (HK)

(72) Inventors: Wai Hang Raymond CHU, Chai Wan (HK); Man Yin Arthur Newton CHU, Chai Wan (HK); Fu Keung Derek YAU, Chai Wan (HK)

(21) Appl. No.: 17/520,218

(22) Filed: Nov. 5, 2021

(51) Int. Cl. H01R 13/713; H01R 13/66

(52) U.S. Cl. CPC H01R 13/7137; H01R 13/6683

(57) ABSTRACT

A thermal protection plug, provides a temperature sensor I, which is directly contact with the neutral wire terminal, so as the heat transferring from neutral wire terminal to the temperature sensor keeps prompt and improve the response delay to cut-off the power switch. And because the negative pole of DC is collinear with the neutral wire terminal, it means that the temperature sensor I can use a low voltage isolation sensor and it is safer even though the breakdown between the shell and the pins of the temperature sensor I.

### FIELD OF THE INVENTION

The present invention relates to a power plug, especially a power plug with thermal protection.

### BACKGROUND OF THE INVENTION

The power plug is a device for the electrical equipment connecting to the electric wire. The higher power of the electrical equipment, the higher current is needed. If the power plug has loose contact with the socket, the resistance value of the connection will be high and will cause high temperature while it is crossing high current. That possibly cause fire danger.

So in prior technique, thermal plug is provided to check the temperature of plug’s terminals. When the temperature is much higher than normal, it mean high possiblity of loose contact and then cut off the power to aviod fire danger. In generally, the working voltage of a MCU with a temperature sensor is mostly uder 5 V. But the voltage of a power plug is generally 110 V or 220 V, and that is much higher than the MCU can resist. So the temperature sensor is usally with high voltage isolation to avoid the breakdown. Or the isolation must be added between the temperature sensor and the terminal of the power plug, but that will cause poor heat transfer and lag the response to cut off the power.

### SUMMARY OF THE INVENTION

In view of the aforesaid drawbacks of the prior art, the present invention provides a thermal protection plug, which can use a temperature sensor with low voltage isolation to detect the temperature of the neutral wire terminal of power plug and will not cause breakdown of the low voltage control system.

A thermal protection plug comprising: at least a live wire terminal and a neutral wire terminal, which are installed in a housing; temperature sensor I is provided and attached to the neutral wire terminal for detecting the temperature, which the shell of the temperature sensor I is directly contact with the neutral wire terminal; pins of the temperature sensor I are connected to a control system, the control system includes at least a temperature circuit, a power supply and a power switch; the temperature circuit part connects to the pins of temperature sensor I or collecting the temperature of the neutral wire terminal, and an upper limit temperature is set; the power switch is controlled by the temperature circuit and is connected between the live wire terminal and the electrical equipment; the power supply connects to the live wire terminal and the neutral wire terminal for transforming the AC into DC for the temperature circuit and the negative pole of DC is collinear with the neutral wire terminal; when temperature of the neutral wire terminal is over the upper limit temperature, the temperature circuit sends signal to cut off the power switch.

Further, the temperature sensor I of the neutral wire terminal is low voltage isolation.

Further, a high voltage isolation temperature sensor II is provided and attached to the live wire terminal for detecting the temperature of the live wire terminal, pins of the temperature sensor II are connected to the temperature circuit.

Further, the temperature circuit is a MCU, the pins of temperature sensor I connect to the I/O of MCU; the power switch is a relay, the coil terminals connects to the I/O of MCU by a driver and the contact terminals connect to the live wire terminal.

Further, a zero-crossing circuit is provided for the temperature circuit only turn on the/cut off the power switch while the live wire is zero-crossing.

The invention has the following advantages: the temperature sensor I is directly contact with the neutral wire terminal, so as the heat transferring from neutral wire terminal to the temperature sensor keeps prompt and improve the response delay to cut-off the power switch. And because the negative pole of DC is collinear with the neutral wire terminal, it means that the temperature sensor I can use a low voltage isolation sensor and it is safer even though the breakdown between the shell and the pins of the temperature sensor I.

### BRIEF DESCRIPTION OF THE DRAWINGS

Below are explanations of the invention combining with drawings.

FIG. 1 is the exploded view of first embodiment of the present invention.

FIG. 2 is the exploded view of second embodiment of the present invention.

FIG. 3 is the schematic diagram of the power supply circuit and the zero-crossing circuit.

FIG. 4 is the schematic diagram of the temperature circuit.

FIG. 5 is the schematic diagram of the temperature sensors.

FIG. 6 is the schematic diagram of the power switch.

In the figures: 1. the live wire terminal, 2. the neutral wire terminal, 3. the housing, 4. the temperature sensor I, 5. the control system, 6.the temperature sensor II.

### DESCRIPTION OF THE EMBODIMENTS

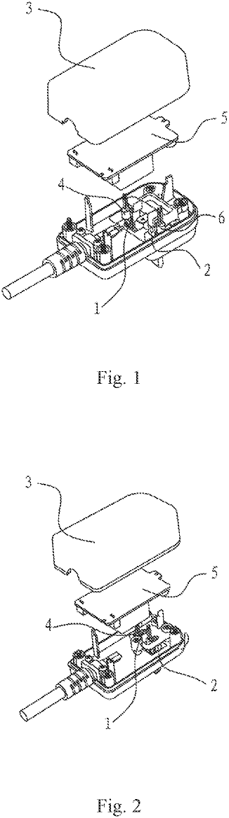

Refer to FIGS. 1 to 3, a thermal protection plug comprising at least a live wire terminal 1 and a neutral wire terminal 2. All the parts of thermal the plug are installed in a housing. It inlcudes a temperature sensor I 4 and it is attached to the neutral wire terminal 2 for detecting the temperature. The shell of the temperature sensor I 4 is directly contact with the neutral wire terminal 2. So that the heat of the neutral wire terminal 2 can directlly transfer to the temperature sensor I 4. That would increase the heat transfer speed and improve the response delay to cut-off the power switch. Generally, the power supply is isolated with AC power. So, the temperature sensor must be high voltage isolation to avoid the breakdown between the shell and the pins. When the breakdown happens, AC will be short into the control system 5 destroying all components and may cause electric shock to user. The most importance aspect of this invention is that the negative pole of DC is collinear with the neutral wire terminal 2. It means that the temperature sensor I 4 can use a low voltage isolation sensor and it is safer even though the breakdown between the shell and the pins of the temperature sensor I 4.

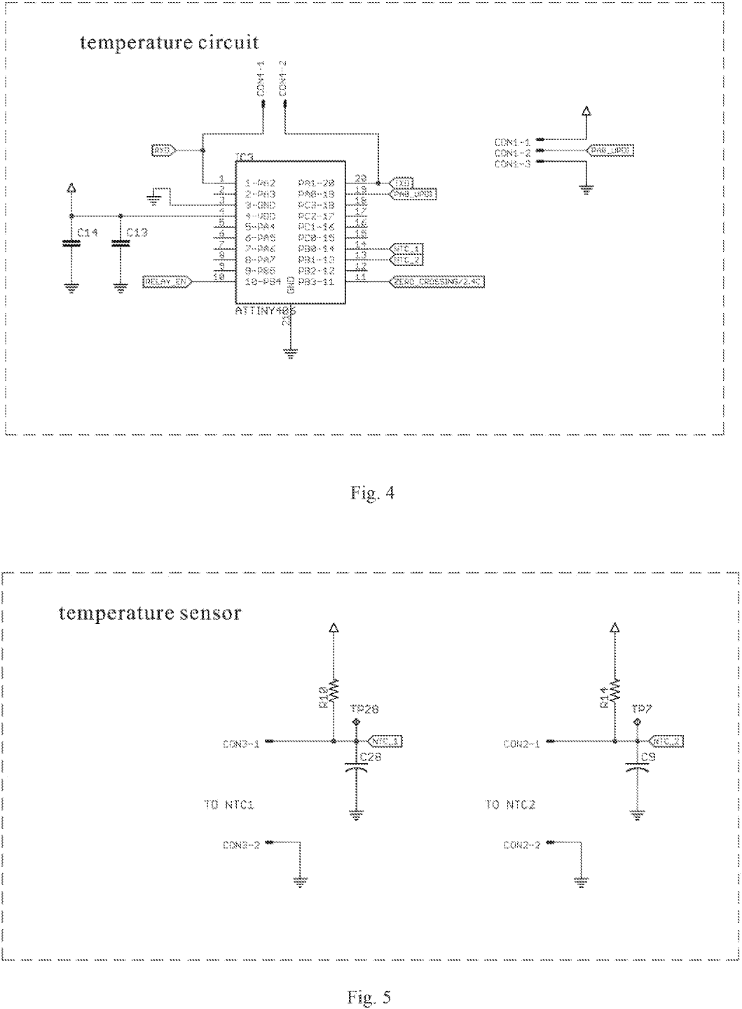

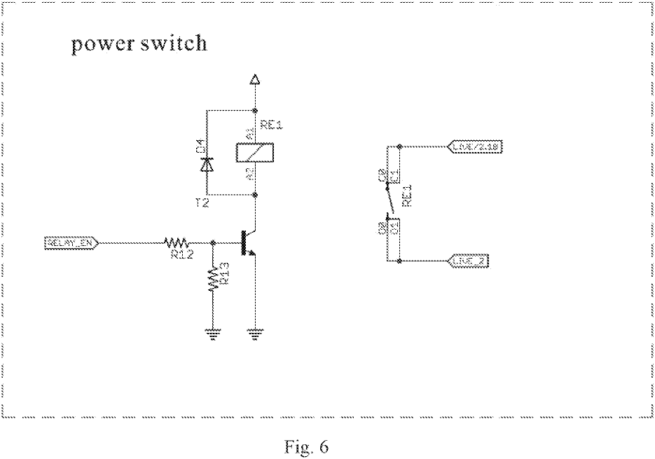

Refer to FIGS. 4 and 5, the control system 5 can collect the temperature data from the temperature sensor I 4 and determin whether the temperature is over the upper limit temperature. It includes at least a temperature circuit, a power supply and a power switch. The temperature circuit is mainly a MCU, the pins of the temperature sensor I 4 connect to the I/O of MCU and the A/D module of the MCU converts the voltage of the temperature sensor I 4 into temperature data. And the MCU will compare the temperature data with the set upper limit temperature.

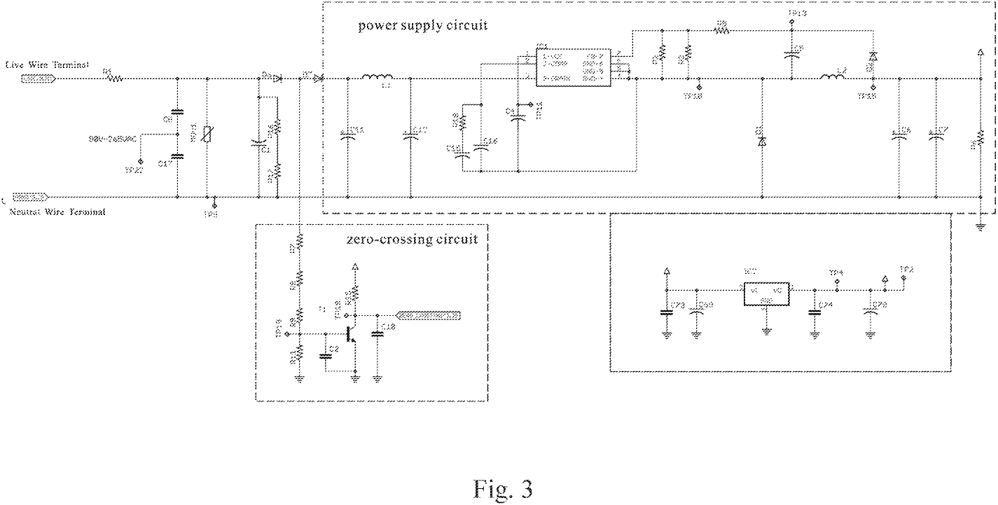

Refer to FIG. 6, the power switch is a relay. The coil terminals of the relay connect to the I/O of MCU. But generally the driven current for the coils is much higher than the output current of the MCU, so a driver must be provided at the output I/O of the MCU. The driver can be a transistor, a MOS driver circuit or a driver IC. The contact terminals of the relay connect to the live wire terminal 1. As we know, when the relay works at the time of the peak of AC, the contact points will spark and may be destroyed. So it is necessary to let the relay works at the zero point of AC. Refer to FIG. 3, A zero-crossing circuit is provided, which includes a diode for rectifying the AC into only positive pulse voltage, a voltage divider circuit for reducing the voltage into not over 5 V, a transistor circuit for identifying the zero point of the pulse voltage and outing signal to the I/O of the MCU, so that let the MCU control the replay only operates while AC is crossing zero.

Except the neutral wire terminal 2, the live wire terminal 1 also has chances of loose contact. So some similar techniq must be set to the live wire terminal 1 and the temperature sensor II 6 is provided and attached to the live wire terminal 1. But if the breakdown happens to the temperature sensor II 6, the high voltage will enter into the low voltage circuits and destroy them. So the temperature sensor II 6 must be high voltage isolation to to avoid the breakdown. Just like the temperature sensor I, the pins of the temperature sensor II 6 connect to the I/O of MCU and the A/D module of the MCU converts the voltage of the temperature sensor II 6 into temperature data. And the MCU will compare the temperature data with the set upper limit temperature.

1. A thermal protection plug comprising: at least a live wire terminal and a neutral wire terminal, which are installed in a housing; temperature sensor I is provided and attached to the neutral wire terminal for detecting the temperature, which the shell of the temperature sensor I is directly contact with the neutral wire termina; pins of the temperature sensor I are connected to a control system, the control system includes at least a temperature circuit, a power supply and a power switch; the temperature circuit part connects to the pins of temperature sensor I for collecting the temperature of the neutral wire terminal, and an upper limit temperature is set; the power switch is controlled by the temperature circuit and is connected between the live wire terminal and the electrical equipment; the power supply connects to the live wire terminal and the neutral wire terminal for transforming the AC into DC for the temperature circuit and the negative pole of DC is collinear with the neutral wire terminal;
when temperature of the neutral wire terminal is over the upper limit temperature, the temperature circuit sends signal to cut off the power switch.

2. The thermal protection plug of claim 1, wherein the temperature sensor I of the neutral wire terminal is low voltage isolation.

3. The thermal protection plug of claim 1, wherein a high voltage isolation temperature sensor II is provided and attached to the live wire terminal for detecting the temperature of the live wire terminal pins of the temperature sensor II are connected to the temperature circuit.

4. The thermal protection plug of claim 1, wherein the temperature circuit is a MCU, the pins of temperature sensor I connect to the I/O of MCU; the power switch is a relay, the coil terminals connects to the I/O of MCU by a driver and the contact terminals connect to the live wire terminal.

5. The thermal protection plug of claim 1, wherein a zero-crossing circuit is provided for the temperature circuit only turn on the/cut off the power switch while the live wire is zero-crossing.
